(19) United States
(12) Patent Application Publication
(10) Pub. No.: US 2002/0182503 A1
(43) Pub. Date: Dec. 5, 2002

(54) Electrochemical storage device and method for producing the same

(75) Inventors: Takuma Asari, Kobe (JP); Susumu Nomoto, Souraku-gun (JP); Mikinari Shimada, Yawata (JP); Kazuyuki Okano, Nara (JP)

Correspondence Address: MERCHANT & GOULD PC, P.O. BOX 2903, MINNEAPOLIS, MN, 55402-0903, US

(73) Assignee: Matsushita Electric Industrial Co., Ltd., Kadoma (JP)

(21) Appl. No.: 10/112,548

(22) Filed: Mar. 28, 2002

(30) Foreign Application Priority Data
Mar. 29, 2001 (JP) 2001-095729

(51) Int. Cl. H01M 4/48; H01M 4/58; H01M 4/52; C01G 1/02; C01G 39/02; C01G 49/02; C01G 53/02; C01D 1/02; C01D 1/04; C01G 55/00; C01G 51/04; C01G 45/02; C01G 31/02; H01M 4/62; H01M 4/50

(52) U.S. Cl. 429/231.1; 429/218.1; 429/232; 429/224; 429/221; 429/231.5; 423/605; 423/592; 423/594; 423/632; 429/231.2; 429/231.95; 423/593; 423/599

(57) ABSTRACT

An electrochemical storage device includes a pair of electrodes, a separator present between the pair of electrodes, and an electrolyte solution with which the electrodes and the separator are impregnated. The electrodes are obtained by allowing at least one selected from a transition metal nitrate compound and a solution of the transition metal nitrate compound to be adsorbed on a carbon-based material and performing an additional treatment so that at least one of a transition metal oxide and a transition metal hydroxide is supported on the carbon-based material. Thus, an electrode material containing a reduced amount of halogenated ions mixed on which a transition metal oxide or a transition metal hydroxide is supported efficiently can be produced, and an electrochemical storage device having a high capacitance and a long life and a method for producing the same can be provided.

### FIELD OF THE INVENTION

The present invention relates to an electrochemical storage device having a high energy density and a long life and a method for producing the same.

### BACKGROUND OF THE INVENTION

Conventionally there have been electric double layer capacitors and secondary batteries as typical electrochemical storage devices, and they already have been available in respective markets in which their characteristics can serve well.

Electric double layer capacitors have a higher output density and a longer life than those of secondary batteries, so that they are used, for example, as backup power sources, which should have high reliability.

On the other hand, secondary batteries have a higher energy density than that of electric double layer capacitors and are the most typical electrical energy storage devices. However, their life is shorter than that of electric double layer capacitors, so that they should be exchanged after use for a certain period of time.

The difference between these devices in their characteristics lies in the mechanism of electrical energy storage. In the electric double layer capacitors, an electrochemical reaction does not occur between electrodes and an electrolyte, and merely ions contained in an electrolyte move during charging and discharging.

Therefore, the electric double layer capacitors deteriorate more slowly than the secondary batteries, and the movement speed of ions is high, so that they have a long life and high output density.

On the other hand, in the secondary batteries, an electrochemical reaction between electrodes and an electrolyte is utilized, so that they are deteriorated by charging and discharging, and the chemical reaction speed is slow. Thus the life is short and the output density is comparatively small.

However, in the secondary batteries, the electrode material itself stores energy in the form of chemical energy, so that the secondary batteries have a higher energy density than that of the electric double layer capacitors, which can store energy only at the interface of the electrodes and the electrolyte.

In this context, electrochemical capacitors having a high output density and a long life, which are characteristics of the electric double layer capacitors, and a high energy density, which is characteristic of the secondary batteries, have been proposed in recent years.

The electrodes used for these electrochemical capacitors may be made of transition metal compounds, typically such as ruthenium oxide.

However, although the theoretical energy density of ruthenium oxide is high, the effective energy density of a device made of this material is low, because of its low conductivity.

In order to solve this problem, JP11(1999)-354389A discloses a method of producing ruthenium oxide by allowing ruthenium chloride as the starting material to be adsorbed on activated carbon fine particles and performing a heat treatment in the air at 470° C. for 40 minutes. This method improves the conductivity so that the conventional problem can be solved, and since a ruthenium chloride solution can be reused so that the use efficiency of ruthenium is increased, a low cost is achieved.

Furthermore, JP2000-36441A discloses a method of obtaining ruthenium hydroxide as the final product by allowing ruthenium chloride to be adsorbed and then performing an alkali neutralization treatment, instead of forming ruthenium oxide as the final product.

However, the conventional methods in which ruthenium chloride is used as the starting material and a heat treatment is performed so that ruthenium oxide is supported on activated carbon fine particles have the following two problems.

The first problem is the limit of energy density due to the restrictions of the activated carbon used to support ruthenium oxide.

In general, many transition metal compounds including ruthenium chloride have high oxidation ability, and the activated carbon fine particles have the property of being oxidized readily.

The inventors of the present invention actually carried out a heat treatment by the method disclosed in JP 11(1999)-354389 with various activated carbons on which ruthenium chloride was adsorbed, and found that especially in the systems employing an activated carbon having a large specific surface area and a high concentration of functional groups, the activated carbon was burned before ruthenium oxide was produced, so that these systems could not be used as an electrode material.

If the period for the heat treatment is extremely short, it is possible to control burning to some extent, but in that case, most of the ruthenium chloride adsorbed in minute pores is not converted to ruthenium oxide. Therefore, the capacitance density cannot be improved.

On the other hand, the activated carbon having a high concentration of functional groups provides the advantage that the electric double layer capacitance on the surface that has not fully supported ruthenium oxide can be used as energy density, and therefore there is the need of allowing the activated carbon having a large specific surface area and a high concentration of functional groups to support transition metal oxide efficiently at a high heat treatment temperature.

The second problem is a question of reliability due to residual halogen compounds. After supporting, if chlorine ions that are not vaporized and remain on the activated carbon are dissolved in an electrolyte, various detriments such as erosion to a case or deterioration in a capacitance life test are caused, which reduces reliability. This problem also arises in the process of forming ruthenium hydroxide by alkali neutralization of ruthenium chloride without performing a heat treatment.

### SUMMARY OF THE INVENTION

Therefore, with the foregoing in mind, it is an object of the present invention to provide an electrochemical storage device having a high capacitance and a long life and a method for producing the same by producing an electrode material that is free from halogenated ions as much as possible and efficiently supports a transition metal oxide or a transition metal hydroxide.

An electrochemical storage device of the present invention includes a pair of electrodes, a separator present between the pair of electrodes, and an electrolyte solution with which the electrodes and the separator are impregnated. The electrodes are obtained by allowing at least one selected from a transition metal nitrate compound and a solution of the transition metal nitrate compound to be adsorbed on a carbon-based material and performing an additional treatment so that at least one of a transition metal oxide and a transition metal hydroxide is supported on the carbon-based material.

According to another aspect of the present invention, a method for producing an electrochemical storage device including a pair of electrodes, a separator present between the pair of electrodes, and an electrolyte solution with which the electrodes and the separator are impregnated is characterized in that the electrodes are formed by allowing at least one selected from a transition metal nitrate compound and a solution of the transition metal nitrate compound to be adsorbed on a carbon-based material and performing an additional treatment so that at least one of a transition metal oxide and a transition metal hydroxide is supported on the carbon-based material.

### BRIEF DESCRIPTION OF THE DRAWINGS

FIG. 1 is a cross-sectional view showing the structure of an electrochemical storage device of one embodiment of the present invention.

FIG. 2 is a chart showing the results of a thermal analysis in Example 1 of the present invention.

FIG. 3 is a chart showing the results of an X-ray analysis in Example 1 of the present invention.

FIG. 4 is a chart showing the results of cyclic voltammetry of an activated carbon fiber electrode on which ruthenium oxide or ruthenium hydroxide is adsorbed in Example 1 and an activated carbon fiber electrode that has not been subjected to an adsorption treatment in Comparative Example 1.

### DESCRIPTION OF THE PREFERRED EMBODIMENTS

There are two approaches to produce oxide or hydroxide using a transition metal nitrate compound as the starting material, that is, a heat treatment method at a temperature in which an activated carbon is not burned, and an alkali neutralization treatment method in which an activated carbon is not burned at all.

If a transition metal oxide or a transition metal hydroxide is supported on an active carbon having a large specific surface area and a high concentration of functional groups by these methods, there is not only an increase of the capacitance stemming from the transition metal oxide or the transition metal hydroxide, but also an increase of the electric double layer capacitance stemming from the activated carbon. Thus the electrochemical storage device made of the above-described electrode material has a high capacitive component.

In particular, in the heat treatment method, nitrate ions present in a transition metal nitrate compound serve as the supply source of oxygen atoms, so that even in an inert atmosphere in which there is no oxygen atom, a transition metal oxide is produced and supported on electrode activated carbons. In both the heat treatment method and the alkali neutralization method, by using a nitrate compound as the starting material, the content of residual halogen in the electrode material can be reduced so that high reliability can be achieved.

Therefore, in the present invention, it is preferable that a halide other than that inevitably mixed in the electrode material is not present. More specifically, a halide on the order of 10 ppm usually will be inevitably present, and therefore it is preferable that the contamination is restricted to less than 20 ppm.

Hereinafter, embodiments of the present invention will be described with reference to the accompanying drawings.

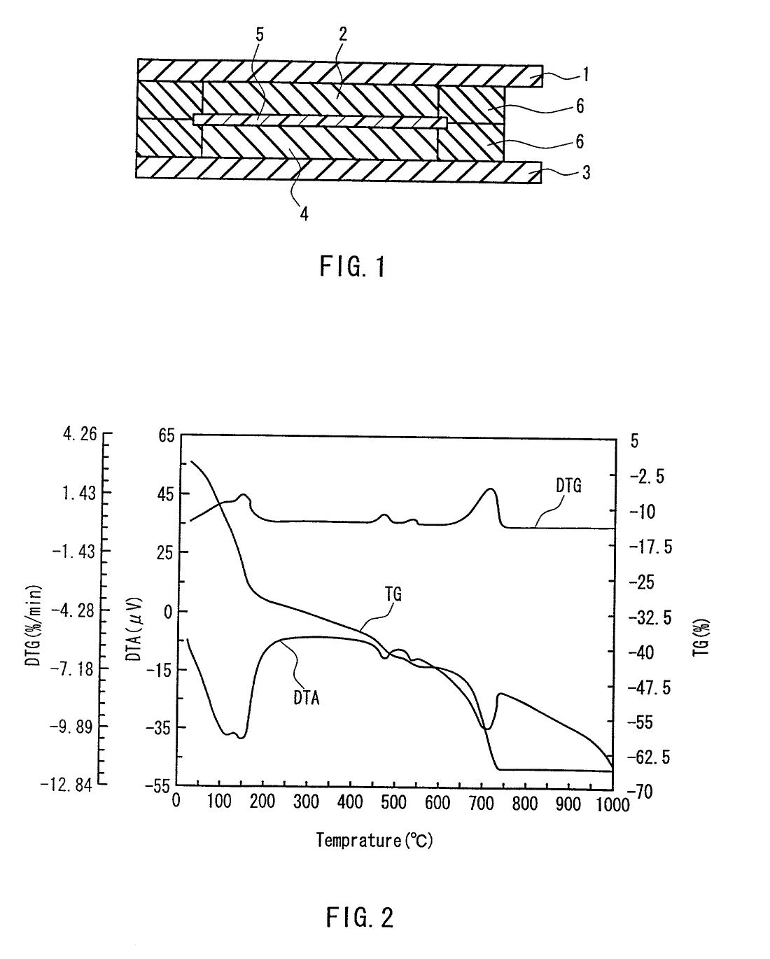

FIG. 1 is a cross-sectional view showing an electrochemical storage device of an embodiment of the present invention. In this electrochemical storage device, an ion permeable separator 5 is present between a positive activated carbon 2 positioned on a positive collector 1 and a negative activated carbon 4 positioned on a negative collector 3, and an insulating rubber 6 electrically insulates the positive collector 1 from the negative collector 3.

At least one of the positive activated carbon 2 and the negative activated carbon 4 contains a transition metal oxide typified by ruthenium oxide or a transition metal hydroxide, and the atomic value of the oxide or the hydroxide is changed continuously so that electrochemical energy is stored. Therefore, it is desirable that the content of the transition metal oxide per surface area of the activated carbon is large to improve the energy density, but if the transition metal oxide is contained too much so as to cover the surface of the activated carbon, the electric double layer capacitance to be formed on the surface of the activated carbon cannot be used. For this reason, it is preferable that the transition metal oxide is contained in an amount of 0.01 to 30 wt % with respect to the carbon-based material. If a porous activated carbon having a specific surface area of 500 m²/g or more and 4000 m²/g or less is used as the activated carbon, the advantage of the present invention can be provided. In particular, a fibrous activated carbon is preferable.

It seems that especially Ru, V, Cr, Mn, Mo, W and the elements of Group VIII (Fe, Co, Tc, Rh, Re, Os, Ir, Ni, and Pd) among the transition metals provide a significant advantage of the present invention. For example, if they are expressed by transition metal nitrate compounds, it is preferable to use at least one selected from ruthenium nitrate, vanadium nitrate, tungsten nitrate, molybdenum nitrate, chromium nitrate, manganese nitrate, iron nitrate, rhodium nitrate, osmium nitrate and iridium nitrate.

The inventors of the present invention carried out experiments with ruthenium nitrate as the starting material to allow ruthenium oxide or ruthenium hydroxide to be supported on electrode activated carbon by using ruthenium as the transition metal. The following three methods can be used to allow ruthenium oxide or ruthenium hydroxide to be supported on activated carbon using ruthenium nitrate as the starting material.

First, an activated carbon may be immersed in a ruthenium nitrate solution, and then the removed activated carbon is dried and subjected to a heat treatment in a nitrogen atmosphere. This heat treatment makes it possible that nitrate ions present in the ruthenium nitrate serve as the supply source of oxygen atoms so that ruthenium oxide can be produced in the nitrogen atmosphere that is free from oxygen atoms and can be supported on the electrode activated carbon. This reaction can be expressed as chemical formula (1) below:

Ru(NO₃)₃→(1−n)Ru(NO₃)₃+nRuO₂+3nNOₓ, where x=7/3 (1)

Secondly, an activated carbon may be immersed in a ruthenium nitrate solution, and then the removed activated carbon is dried and subjected to a heat treatment in an inert gas atmosphere to which oxygen or water vapor is added. This heat treatment makes it possible that the added oxygen or water vapor serves as the supply source of oxygen atoms so that ruthenium oxide can be produced and supported on the electrode activated carbon. However, the partial gas pressure of the added oxygen or water vapor determines the burning temperature of the activated carbon, and therefore it is necessary to determine the partial gas pressure in accordance with the type of the activated carbon so as to prevent the activated carbon from burning. More specifically, it is preferable that as the activated carbon has a higher reactivity, the partial pressure of the oxygen or the water vapor is lower. However, a higher partial pressure of the oxygen or the water vapor can shorten the heat treatment time. In particular, when 0 to 30% by volume of oxygen is supplied into an inert gas, the heat treatment at 150 to 750° C. is required, but as the quantity of the oxygen becomes larger, the burning temperature of the activated carbon becomes lower, so that a heat treatment should be performed at a low temperature.

This reaction when oxygen is added can be expressed as chemical formula (2) below:

Ru(NO₃)₃+xO₂→RuO₂+3nNO_{y}, where y=(2x+7)/3 (2)

Thirdly, an activated carbon may be immersed in a ruthenium nitrate solution into which a NaOH solution is dripped slowly. As the alkaline aqueous solution used for alkali neutralization treatment, not only NaOH but also a KOH, NaHCO₃, Na₂CO₃, or NH₄OH aqueous solution can be used. However, a NaOH aqueous solution is the most preferable and it is preferable that the pH is not higher than 7 in the additional treatment process.

The concentration of the alkali substance in the alkali aqueous solution preferably is in the range from 0.001 to 10 N, more preferably in the range from 0.01 to 4 N.

This alkali neutralization treatment produces ruthenium hydroxide, and residual sodium ions and nitrate ions can be removed by washing the activated carbon on which the ruthenium hydroxide is adsorbed with water, and then the activated carbon is dried at 110° C. so that ruthenium oxide or ruthenium hydroxide is produced and supported on the electrode activated carbon.

In the first and the second methods described above, the temperature for the heat treatment should be at least 400° C., whereas in the third method of the neutralization treatment method, the heat treatment can be performed at a low temperature, which is advantageous in that ruthenium oxide or ruthenium hydroxide can be produced with an activated carbon having a large number of functional groups.

This reaction can be expressed as chemical formula (3) below:

Ru(OH)₃→RuO₂+H₂O (3)

However, the chemical reaction formulae described above are merely examples, and not limiting for the present invention.

By the above-described methods, a larger amount of ruthenium oxide or ruthenium hydroxide can be formed on the activated carbon than by conventional methods, so that a device having a high energy density can be achieved and the content of the residual halogen in the electrode material can be reduced, which leads to a long life.

As described above, in the present invention, an electrode material on which a transition metal oxide or a transition metal hydroxide is supported efficiently is produced with various activated carbons, for example, activated carbons having a large specific surface area or a high concentration of functional groups, which provides a large electric double layer capacitance. Furthermore, by reducing the content of residual halogen, an electrochemical storage device having a high capacitance and a long life can be produced.

### EXAMPLES

Hereinafter, the present invention will be described by way of examples more specifically, but the present invention is not limited to the following examples.

### Example 1

Example 1 describes a measurement of the static capacitance of a sample obtained by allowing ruthenium nitrate to be adsorbed on activated carbon fibers and performing a heat treatment in a nitrogen atmosphere.

First, 5 g of activated carbon fibers (manufactured by Kynol, trade name “#5092”) having a specific surface area of 1500 m²/g were immersed in 50 ml of a ruthenium nitrate solution (manufactured by Tanaka Precious Metals, the content of ruthenium was 50 g/L) for impregnation under a vacuum and then left undisturbed. After 24 hours, the supernatant of the aqueous solution turned from dark blackish brown to light blackish brown, which indicated that the ruthenium nitrate was adsorbed on the activated carbon fibers.

The activated carbon fibers that had been subjected to the adsorption treatment were removed and dried at 110° C., and then a heat treatment was performed in which the activated carbon fibers were heated from room temperature to 600° C. at a temperature-increase rate of 300° C./hr in a nitrogen atmosphere, and then cooled to room temperature at a cooling rate of 1200° C./hr.

This heat treatment converted the ruthenium nitrate adsorbed on the activated carbon fibers to ruthenium oxide or ruthenium hydroxide.

The activated carbon fibers that had been subjected to a heat treatment after the adsorption treatment in an amount of 0.1362 g and the activated carton fibers (manufactured by Kynol, trade name “#5092”) for the counter electrode in an amount of 0.2823 g were wound with platinum wires, and were immersed in a 30 wt % dilute sulfuric acid solution for impregnation under a vacuum.

As shown in the thermogravimetry (TG) curve of Example 1 in FIG. 2, since the activated carbon fibers are burned in a heat treatment at 750° C. or higher, the heat treatment in a nitrogen atmosphere should be performed at a temperature of less than 750° C. In FIG. 2, DTA denotes differential thermal analysis, and DTG denotes differential thermogravimetry curve. The DTA curve and the DTG curve also indicate that the heat treatment in a nitrogen atmosphere should be performed at a temperature of less than 750° C.

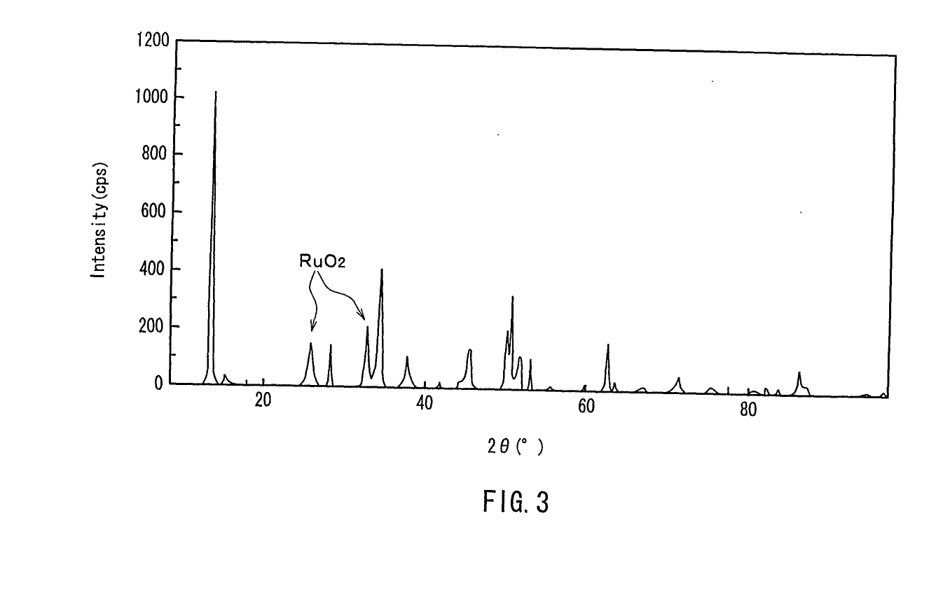

FIG. 3 shows the results of X-ray analysis of the activated carbon fibers after the heat treatment as described above obtained in Example 1, and it confirmed the production of RuO₂ adsorbed on the activated carbon fibers after the heat treatment.

Next, the static capacitance of the activated carbon fiber electrode on which ruthenium oxide or ruthenium hydroxide was adsorbed was evaluated, using a 30 wt % dilute sulfuric acid solution as the electrolyte, silver-silver chloride electrodes as the reference electrodes, and a cyclic voltammgram method with three electrodes as the measuring method.

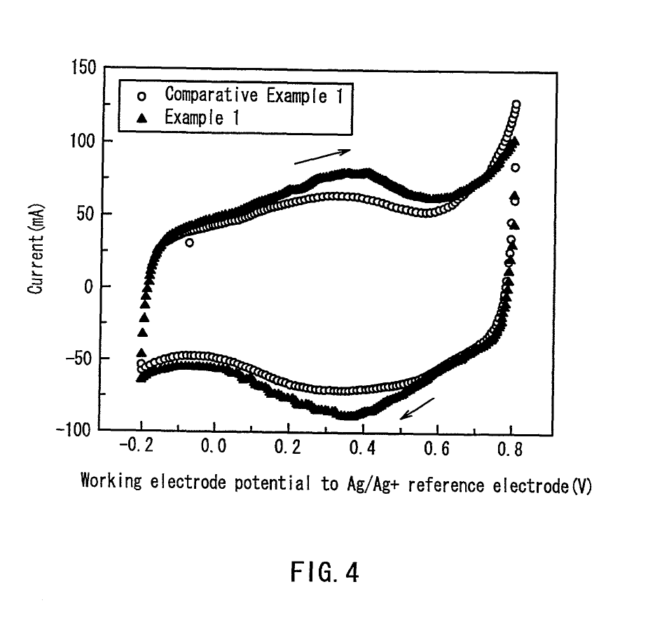

FIG. 4 shows the results of the cyclic voltammetry performed at a voltage sweep rate of 0.25 mV/sec in Example 1 and Comparative Example 1. In the following comparative examples and examples, the same measurement was performed. For evaluation, the current amount was integrated with a coulomb-meter while the working electrode potential was swept from −0.2 to +0.8 V with respect to the Ag/Ag⁺ reference electrode, and was calculated in terms of the sample weight. This calculation method was used in all the following examples and only the static capacitance per weight is described in the following.

An evaluation was performed in this manner, and as shown in Table 1, the static capacitance per weight was 283.80 F/g for the activated carbon fiber electrode on which ruthenium oxide was adsorbed. This value is 1.32 times larger than 215.26 F/g for the activated carbon fiber electrode of Comparative Example 1, and 1.14 times larger than 248.26 F/g for the activated carbon fiber electrode of Comparative Example 2, which was obtained with ruthenium chloride as the starting material.

### Example 2

Example 2 describes a measurement of the static capacitance of a sample obtained by allowing ruthenium nitrate to be adsorbed on activated carbon fibers and performing a heat treatment in an atmosphere of mixed gas of nitrogen and oxygen having a partial pressure ratio of 90:10 (nitrogen:oxygen).

First, 5 g of activated carbon fibers (manufactured by Kynol, trade name “#5092”) having a specific surface area of 1500 m²/g were immersed in 50 ml of a ruthenium nitrate solution (manufactured by Tanaka Precious Metals, the content of ruthenium was 50 g/L) for impregnation under a vacuum and then left undisturbed. After 24 hours, the supernatant of the aqueous solution turned from dark blackish brown to light blackish brown, which indicated that the ruthenium nitrate was adsorbed on the activated carbon fibers.

The activated carbon fibers that had been subjected to the adsorption treatment were removed and dried at 110° C., and then a heat treatment was performed in which the activated carbon fibers were heated from room temperature to 520° C. at a temperature-increase rate of 300° C./hr in an atmosphere of mixed gas of nitrogen:oxygen at a partial pressure ratio of 90:10, and then cooled to room temperature at a cooling rate of 1200° C /hr.

This heat treatment converted the ruthenium nitrate adsorbed on the activated carbon fibers to ruthenium oxide or ruthenium hydroxide.

The activated carbon fibers that had been subjected to a heat treatment after the adsorption treatment in an amount of 0.1382 g and the activated carton fibers (manufactured by Kynol, trade name “#5092”) for the counter electrode in an amount of 0.2823 g were wound with platinum wires, and were immersed in a 30 wt % dilute sulfuric acid solution for impregnation under a vacuum.

Next, the static capacitance of the activated carbon fiber electrode on which ruthenium oxide or ruthenium hydroxide was adsorbed was evaluated, using a 30 wt % dilute sulfuric acid solution as the electrolyte, silver-silver chloride electrodes as the reference electrodes, and a cyclic voltametric method with three electrodes as the measuring method.

An evaluation was performed in this manner, and as shown in Table 1, the static capacitance per weight was 415.95 F/g for the activated carbon fiber electrode on which ruthenium oxide or ruthenium hydroxide was adsorbed. This value is 1.93 times larger than 215.26 F/g for the activated carbon fiber electrode of Comparative Example 1, and 1.68 times larger than 248.26 F/g for the activated carbon fiber electrode of Comparative Example 2, which was obtained with ruthenium chloride as the starting material.

### Example 3

Example 3 describes a measurement of the static capacitance of a sample obtained by allowing ruthenium nitrate to be adsorbed on activated carbon fibers and performing an alkali neutralization treatment.

First, 5 g of activated carbon fibers (manufactured by Kynol, trade name “#5092”) having a specific surface area of 1500 m²/g were immersed in 50 ml of a ruthenium nitrate solution (manufactured by Tanaka Precious Metals, the content of ruthenium was 50 g/L) for impregnation under a vacuum and then left undisturbed. After 24 hours, the supernatant of the aqueous solution turned from dark blackish brown to light blackish brown, which indicated that the ruthenium nitrate was adsorbed on the activated carbon fibers.

After dripping a sodium hydroxide solution to this solution, the activated carbon fibers were removed and washed with water so that residual sodium ions and nitrate ions were removed, and then dried at 110° C. in a dryer.

The activated carbon fibers that had been subjected to an alkali neutralization treatment for adsorption of ruthenium oxide in an amount of 0.1372 g and the activated carbon fibers (manufactured by Kynol, trade name “#5092”) for the counter electrode in an amount of 0.2823 g were wound with platinum wires, and were immersed in a 30 wt % dilute sulfuric acid solution for impregnation under a vacuum.

Next, the static capacitance of the activated carbon fiber electrode on which ruthenium oxide or ruthenium hydroxide was adsorbed was evaluated, using a 30 wt % dilute sulfuric acid solution as the electrolyte, silver-silver chloride electrodes as the reference electrodes, and a cyclic voltammetric method with three electrodes as the measuring method.

An evaluation was performed in this manner, and as shown in Table 1, and the static capacitance per weight was 385.37 F/g for the activated carbon fiber electrode on which ruthenium oxide or ruthenium hydroxide was adsorbed. This value is 1.79 times larger than 215.26 F/g for the activated carbon fiber electrode of Comparative Example 1, and 1.55 times larger than 248.26 F/g for the activated carbon fiber electrode of Comparative Example 2, which was obtained with ruthenium chloride as the starting material.

### Comparative Example 1

Comparative Example 1 describes a measurement of the static capacitance of activated carbon fibers.

Activated carbon fibers (manufactured by Kynol, trade name “#5092”) that are not subjected to the adsorption treatment in an amount of 0.0803 g and activated carbon fibers (manufactured by Kynol, trade name “#5092”) for a counter electrode in an amount of 0.2823 g were wound with platinum wires, and were immersed in a 30 wt % dilute sulfuric acid solution for impregnation under a vacuum.

Then, the static capacitance of the activated carbon fiber electrodes that were not subjected to the adsorption treatment was evaluated, using a 30 wt % dilute sulfuric acid solution as the electrolyte, silver-silver chloride electrodes as the reference electrodes, and a cyclic voltammetric method with three electrodes as the measuring method.

Table 1 shows the result of the evaluation. The static capacitance per weight of the activated carbon fiber electrodes that were not subjected to the adsorption treatment of this comparative example was 215.26 F/g.

### Comparative Example 2

Comparative Example 2 describes a measurement of the static capacitance of a sample obtained by allowing ruthenium chloride to be adsorbed on activated carbon fibers and performing a heat treatment in a nitrogen atmosphere.

First, 0.25 g of ruthenium chloride were dissolved in 50 ml of distilled water to produce a dark red aqueous solution, and 5 g of activated carbon fibers (manufactured by Kynol, trade name “#5092”) having a specific surface area of 1500 m²/g were immersed in the aqueous solution for impregnation under a vacuum and then left undisturbed.

After 24 hours, the supernatant of the aqueous solution turned from dark red to light red, which indicated that the ruthenium chloride was adsorbed on the activated carbon fibers.

The activated carbon fibers that had been subjected to the adsorption treatment were removed and dried at 110° C., and then a heat treatment was performed in which the activated carbon fibers were heated from room temperature to 600° C. at a temperature-increase rate of 300° C./hr in a nitrogen atmosphere, and then cooled to room temperature at a cooling rate of 1200° C./hr.

This heat treatment converted the ruthenium chloride adsorbed on the activated carbon fibers to ruthenium oxide or ruthenium hydroxide.

The activated carbon fibers that had been subjected to a heat treatment after the adsorption treatment in an amount of 0.1374 g and the activated carton fibers (manufactured by Kynol, trade name “#5092”) for the counter electrode in an amount of 0.2823 g were wound with platinum wires, and were immersed in a 30 wt % dilute sulfuric acid solution for impregnation under a vacuum.

Next, the static capacitance of the activated carbon fiber electrode on which ruthenium oxide or ruthenium hydroxide was adsorbed was evaluated, using a 30 wt % dilute sulfuric acid solution as the electrolyte, silver-silver chloride electrodes as the reference electrodes, and a cyclic voltammgram method with three electrodes as the measuring method.

An evaluation was performed in this manner, and as shown in Table 1, the static capacitance per weight of the activated carbon fiber electrode on which ruthenium oxide or ruthenium hydroxide of this comparative example was adsorbed was 248.26 F/g, which is 1.15 times larger than 215.26 F/g for the activated carbon fiber electrode of Comparative Example 1.

TABLE 1

| | Material | | Static | | |
|---|---|---|---|---|---|
| | added to | | capacitance | Capacitance | Capacitance |
| | activated | Additional | per weight | ratio to Com. | ratio to Com. |
| | carbon | treatment | (F/g) | Ex. 1 | Ex. 2 |
| Ex. 1 | Ru(NO₃)₃ | Nitrogen | 283.80 | 1.32 | 1.14 |
| Ex. 2 | Ru(NO₃)₃ | Air | 415.95 | 1.93 | 1.68 |
| Ex. 3 | Ru(NO₃)₃ | NaOH | 385.37 | 1.79 | 1.55 |
| | | solution | | | |
| Com. | None | none | 215.26 | 1.00 | 0.87 |
| Ex. 1 | | | | | |
| Com. | RuCl₃ | nitrogen | 248.26 | 1.15 | 1.00 |
| Ex. 2 | | | | | |

As described above, Examples 1 to 3 of the present invention can provide electrode materials having higher static capacitance per weight and electrochemical storage devices having higher capacitance than Comparative Examples 1 and 2.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. An electrochemical storage device comprising a pair of electrodes, a separator present between the pair of electrodes, and an electrolyte solution with which the electrodes and the separator are impregnated,
wherein at least one of the electrodes is obtained by allowing at least one selected from a transition metal nitrate compound and a solution of the transition metal nitrate compound to be adsorbed on a carbon-based material and performing an additional treatment so that at least one of a transition metal oxide and a transition metal hydroxide is supported on the carbon-based material.

2. The electrochemical storage device according to claim 1, wherein the additional treatment is a heat treatment.

3. The electrochemical storage device according to claim 1, wherein the additional treatment is immersing in an alkaline aqueous solution.

4. The electrochemical storage device according to claim 1, wherein the transition metal nitrate compound is at least one selected from the group consisting of ruthenium nitrate, vanadium nitrate, tungsten nitrate, molybdenum nitrate, chromium nitrate, manganese nitrate, iron nitrate, rhodium nitrate, osmium nitrate and iridium nitrate.

5. The electrochemical storage device according to claim 1, wherein the carbon material is a porous carbon having a specific surface area of 500 m²/g or more and 4000 m²/g or less.

6. The electrochemical storage device according to claim 1, wherein the carbon material is activated carbon fibers.

7. The electrochemical storage device according to claim 1, wherein no halide is added by the formation of the oxide or hydroxide in the electrode material.

8. The electrochemical storage device according to claim 1, wherein the maximum halide level of no more than 20 ppm in the electrode material.

9. The electrochemical storage device according to claim 1, wherein the transition metal nitrate compound is supported in a range from 0.01% by mass to 30% by mass.

10. A method for producing an electrochemical storage device comprising a pair of electrodes, a separator present between the pair of electrodes, and an electrolyte solution with which the electrodes and the separator are impregnated,
wherein at least one of the electrodes is formed by allowing at least one selected from a transition metal nitrate compound and a solution of the transition metal nitrate compound to be adsorbed on a carbon-based material and performing an additional treatment so that at least one of a transition metal oxide and a transition metal hydroxide is supported on the carbon-based material.

11. The method for producing an electrochemical storage device according to claim 10, wherein the additional treatment is a heat treatment.

12. The method for producing an electrochemical storage device according to claim 10, wherein the additional treatment is immersing in an alkaline aqueous solution.

13. The method for producing an electrochemical storage device according to claim 10, wherein the transition metal nitrate compound is at least one selected from the group consisting of ruthenium nitrate, vanadium nitrate, tungsten nitrate, molybdenum nitrate, chromium nitrate, manganese nitrate, iron nitrate, rhodium nitrate, osmium nitrate, iridium nitrate, cobalt nitrate, nickel nitrate and palladium nitrate.

14. The method for producing an electrochemical storage device according to claim 10, wherein the carbon material is activated carbon fibers.

15. The method for producing an electrochemical storage device according to claim 10, wherein the carbon material is a porous carbon having a specific surface area of 500 m²/g or more and 4000 m²/g or less.

16. The method for producing an electrochemical storage device according to claim 10, wherein no halide is added by the formation of the oxide or hydroxide in the electrode material.

17. The method for producing an electrochemical storage device according to claim 10, wherein the maximum halide level of no more than 20 ppm in the electrode material.

18. The method for producing an electrochemical storage device according to claim 11, wherein the heat treatment is performed in an inert gas atmosphere including oxygen gas in an amount of 0 to 30 vol %.

19. The method for producing an electrochemical storage device according to claim 11, the heat treatment is performed in a range from 150° C. or more and 750° C. or less.

20. The method for producing an electrochemical storage device according to claim 12, wherein the alkaline aqueous solution is a solution of at least one selected from the group consisting of NaOH, KOH, NaHCO₃, Na₂CO₃ and NH₄OH.

21. The method for producing an electrochemical storage device according to claim 20, wherein a concentration of an alkali substance in the alkaline aqueous solution is 0.001 to 10 N.

22. The method for producing an electrochemical storage device according to claim 10, wherein after immersing in an alkaline aqueous solution, free sodium ions and nitrate ions are removed by washing.
